(19) United States
(12) Patent Application Publication
(10) Pub. No.: US 2022/0309575 A1
(43) Pub. Date: Sep. 29, 2022

(54) SYSTEM AND METHOD FOR AUTOMATION OF PRICING DETERMINATIONS FOR WHOLESALE LOANS

(71) Applicant: JPMorgan Chase Bank, N.A., New York, NY (US)

(72) Inventors: Gurvinder Pal SINGH, Palatine, IL (US); Pradeep JHA, Mumbai (IN); Erin HICKEY, Park Ridge, IL (US)

(73) Assignee: JPMorgan Chase Bank, N.A., New York, NY (US)

(21) Appl. No.: 17/319,370

(22) Filed: May 13, 2021

(30) Foreign Application Priority Data
Mar. 26, 2021 (IN) 202111013278

(51) Int. Cl. G06Q 40/02; G06Q 20/40

(52) U.S. Cl. CPC G06Q 40/025; G06Q 20/405

(57) ABSTRACT

A method and a system for automating a process for determining pricing for a loan is provided. The method includes: receiving pricing rules that are applicable for the loan; analyzing each pricing rule; determining, based on the analysis, at least one proposed price for the loan; and notifying a user of the proposed prices for the loan. The analysis of each pricing rule includes a determination of a corresponding base interest rate, a corresponding spread value, a corresponding floor value, and a corresponding cap value for the loan.

### CROSS-REFERENCE TO RELATED APPLICATIONS

This application claims priority benefit from Indian Application No. 202111013278, filed Mar. 26, 2021, which is hereby incorporated by reference in its entirety.

### BACKGROUND

### 1. Field of the Disclosure

This technology generally relates to systems and methods for making pricing determinations for wholesale loans, and more particularly, to systems and methods for automating a process for using pricing rules, interest rate reference data, and business scenarios to determine possible pricing for wholesale loans.

### 2. Background Information

The pricing rules of a wholesale lending facility consist of a complex grid of nested formulas which, when resolved, indicate types of base rate options that are available to a borrower, as well as associated spreads, caps, and floors which would be applicable for loans to be drawn by the borrower. The pricing rules provide a financial institution with a methodical approach for structuring an optimal pricing of loans.

As a result of the length and complexity of such pricing rules, the process of analyzing the pricing rules and determining pricing for wholesale loans is often time-consuming and cumbersome. Accordingly, there is a need for a mechanism for automating a process of analyzing the pricing rules and using interest rate reference data to determine possible pricing for wholesale loans based on various business scenarios.

### SUMMARY

The present disclosure, through one or more of its various aspects, embodiments, and/or specific features or sub-components, provides, inter alia, various systems, servers, devices, methods, media, programs, and platforms for automating a process for using pricing rules, interest rate reference data, and business scenarios to determine possible pricing for wholesale loans.

According to an aspect of the present disclosure, a method for automating a process for using pricing rules, interest rate reference data, and business scenarios to determine possible pricing for wholesale loans is provided. The method is implemented by at least one processor. The method includes: receiving, by the at least one processor, at least one pricing rule that is applicable for a loan; analyzing, by the at least one processor, each of the received at least one pricing rule; determining, by the at least one processor based on a result of the analyzing, at least one proposed price for the loan; and notifying, by the at least one processor, a user of the determined at least one proposed price for the loan.

The analyzing may include determining, for each respective pricing rule: a corresponding base interest rate; a corresponding spread value; and at least one from among a corresponding floor value and a corresponding cap value.

Each of the at least one pricing rule may be associated with a respective wholesale lending facility.

Each of the at least one pricing rule may relate to at least one variable benchmark interest rate.

The method may further include obtaining, for each of the at least one benchmark interest rate, a current index reference rate. The determining of the at least one proposed price for the loan may include determining a time interval during which the determined at least one proposed price for the loan remains valid.

The method may further include: when a predetermined time interval has elapsed since the determining of the at least one proposed price for the loan, updating a determination of the least one proposed price for the loan based on a change in the at least one benchmark interest rate.

The predetermined time interval may be greater than 12 hours and less than 48 hours.

The method may further include displaying information that relates to the determined at least one proposed price for the loan on a dashboard user interface associated with a financial institution.

The method may further include: after the determining and before the notifying, retrieving historical information that relates to at least one loan transaction previously executed by the user; selecting a preferred price for the loan from among the determined at least one proposed price for the loan based on the retrieved historical information; and notifying the user of the selected preferred price for the loan.

According to another exemplary embodiment, a computing apparatus for determining a price for a loan is provided. The computing apparatus includes a processor; a memory; and a communication interface coupled to each of the processor and the memory. The processor is configured to: receive, via the communication interface, at least one pricing rule that is applicable for the loan; analyze each of the received at least one pricing rule; determine, based on a result of the analysis, at least one proposed price for the loan; and notify, via the communication interface, a user of the determined at least one proposed price for the loan.

The processor may be further configured to analyze each of the received at least one pricing rule by determining, for each respective pricing rule: a corresponding base interest rate; a corresponding spread value; and at least one from among a corresponding floor value and a corresponding cap value.

Each of the at least one pricing rule may be associated with a respective wholesale lending facility.

Each of the at least one pricing rule may relate to at least one variable benchmark interest rate.

The processor may be further configured to: obtain, for each of the at least one benchmark interest rate, a current index reference rate; and determine a time interval during which the determined at least one proposed price for the loan remains valid.

The processor may be further configured to: when a predetermined time interval has elapsed since the determination of the at least one proposed price for the loan, update the determination of the least one proposed price for the loan based on a change in the at least one benchmark interest rate.

The predetermined time interval may be greater than 12 hours and less than 48 hours.

The processor may be further configured to display information that relates to the determined at least one proposed price for the loan on a dashboard user interface associated with a financial institution.

The processor may be further configured to: after the determination and before the notification, retrieve, from the memory, historical information that relates to at least one loan transaction previously executed by the user; select a preferred price for the loan from among the determined at least one proposed price for the loan based on the retrieved historical information; and notify the user of the selected preferred price for the loan.

According to another exemplary embodiment, a non-transitory computer readable storage medium storing instructions for determining a price for a loan is provided. The storage medium includes executable code which, when executed by a processor, causes the processor to: receive at least one pricing rule that is applicable for the loan; analyze each of the received at least one pricing rule; determine, based on a result of the analysis, at least one proposed price for the loan; and notify a user of the determined at least one proposed price for the loan.

The executable code may be further configured to cause the processor to analyze each of the received at least one pricing rule by determining, for each respective pricing rule: a corresponding base interest rate; a corresponding spread value; and at least one from among a corresponding floor value and a corresponding cap value.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automating a process for using pricing rules, interest rate reference data, and business scenarios to determine possible pricing for wholesale loans.

FIG. 4 is a flowchart of an exemplary process for implementing a method for automating a process for using pricing rules, interest rate reference data, and business scenarios to determine possible pricing for wholesale loans.

FIG. 5 is a flowchart of a process for parsing a pricing rule, according to an exemplary embodiment.

FIG. 6 is a diagram that illustrates a hypothetical rate draw use case, according to an exemplary embodiment.

FIG. 7 is a diagram that illustrates a simulation of a negative rate use case, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

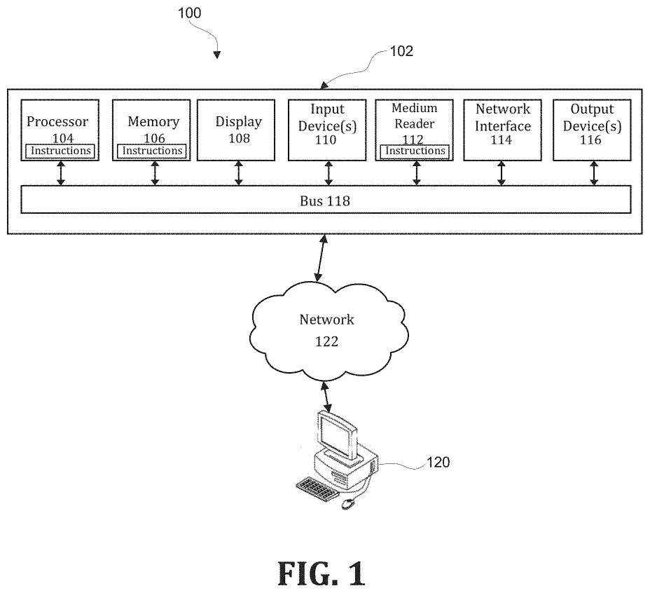

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automating a process for using pricing rules, interest rate reference data, and business scenarios to determine possible pricing for wholesale loans.

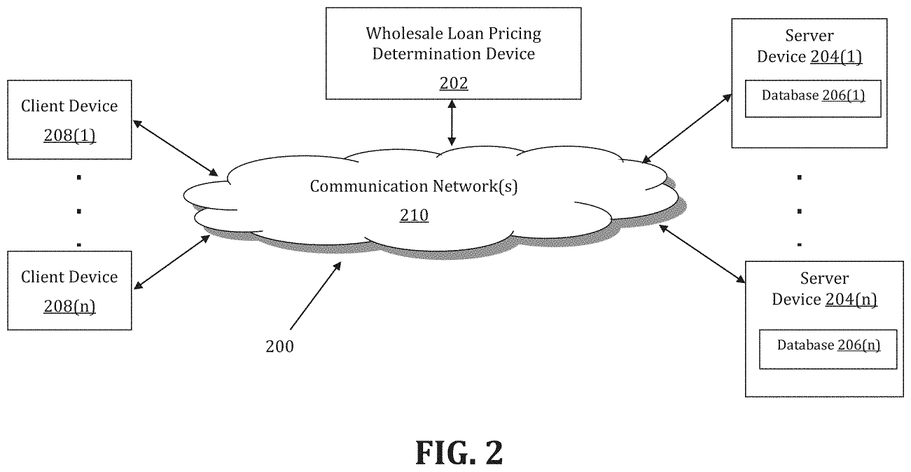

Referring to FIG. 2, a schematic of an exemplary network environment 200 for implementing a method for automating a process for using pricing rules, interest rate reference data, and business scenarios to determine possible pricing for wholesale loans is illustrated. In an exemplary embodiment, the method is executable on any networked computer platform, such as, for example, a personal computer (PC).

The method for automating a process for using pricing rules, interest rate reference data, and business scenarios to determine possible pricing for wholesale loans may be implemented by a Wholesale Loan Pricing Determination (WLPD) device 202. The WLPD device 202 may be the same or similar to the computer system 102 as described with respect to FIG. 1. The WLPD device 202 may store one or more applications that can include executable instructions that, when executed by the WLPD device 202, cause the WLPD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the WLPD device 202 itself, may be located in virtual server(s) running in a cloud-based computing environment rather than being tied to one or more specific physical network computing devices. Also, the application(s) may be running in one or more virtual machines (VMs) executing on the WLPD device 202. Additionally, in one or more embodiments of this technology, virtual machine(s) running on the WLPD device 202 may be managed or supervised by a hypervisor.

In the network environment 200 of FIG. 2, the WLPD device 202 is coupled to a plurality of server devices 204(1)-204(n) that hosts a plurality of databases 206(1)-206(n), and also to a plurality of client devices 208(1)-208(n) via communication network(s) 210. A communication interface of the WLPD device 202, such as the network interface 114 of the computer system 102 of FIG. 1, operatively couples and communicates between the WLPD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the WLPD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and WLPD devices that efficiently implement a method for automating a process for using pricing rules, interest rate reference data, and business scenarios to determine possible pricing for wholesale loans.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The WLPD device 202 may be a standalone device or integrated with one or more other devices or apparatuses, such as one or more of the server devices 204(1)-204(n), for example. In one particular example, the WLPD device 202 may include or be hosted by one of the server devices 204(1)-204(n), and other arrangements are also possible. Moreover, one or more of the devices of the WLPD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the WLPD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to pricing rules and interest rates.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the WLPD device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the WLPD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the WLPD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the WLPD device 202, the server devices 204(1)-204(n), or the client devices 208(1)-208(n), for example, may be configured to operate as virtual instances on the same physical machine. In other words, one or more of the WLPD device 202, the server devices 204(1)-204(n), or the client devices 208(1)-208(n) may operate on the same physical device rather than as separate devices communicating through communication network(s) 210. Additionally, there may be more or fewer WLPD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

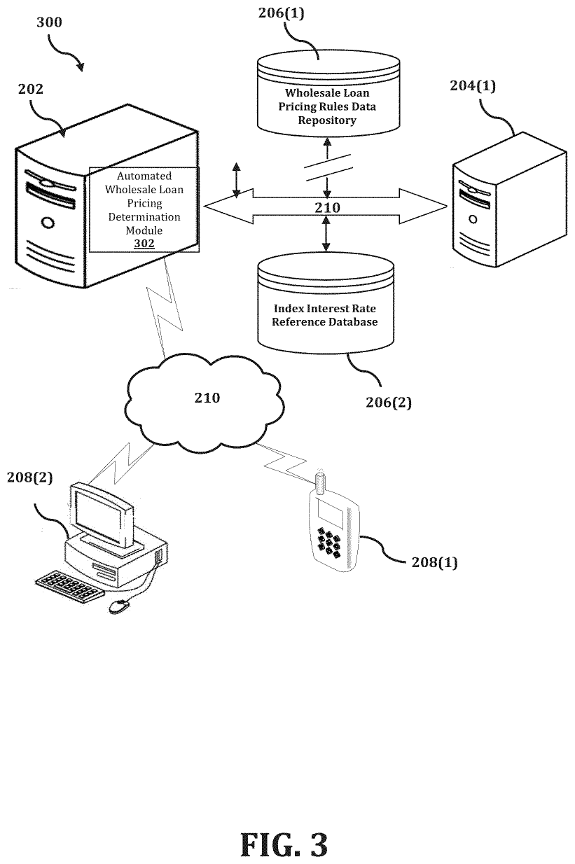

The WLPD device 202 is described and illustrated in FIG. 3 as including an automated wholesale loan pricing determination module 302, although it may include other rules, policies, modules, databases, or applications, for example. As will be described below, the automated wholesale loan pricing determination module 302 is configured to implement a method for automating a process for using pricing rules, interest rate reference data, and business scenarios to determine possible pricing for wholesale loans.

An exemplary process 300 for implementing a mechanism for automating a process for using pricing rules, interest rate reference data, and business scenarios to determine possible pricing for wholesale loans by utilizing the network environment of FIG. 2 is illustrated as being executed in FIG. 3. Specifically, a first client device 208(1) and a second client device 208(2) are illustrated as being in communication with WLPD device 202. In this regard, the first client device 208(1) and the second client device 208(2) may be “clients” of the WLPD device 202 and are described herein as such. Nevertheless, it is to be known and understood that the first client device 208(1) and/or the second client device 208(2) need not necessarily be “clients” of the WLPD device 202, or any entity described in association therewith herein. Any additional or alternative relationship may exist between either or both of the first client device 208(1) and the second client device 208(2) and the WLPD device 202, or no relationship may exist.

Further, WLPD device 202 is illustrated as being able to access a wholesale loan pricing rules data repository 206(1) and an index interest rate reference database 206(2). The automated wholesale loan pricing determination module 302 may be configured to access these databases for implementing a method for automating a process for using pricing rules, index interest rate reference data, and business scenarios to determine possible pricing for wholesale loans.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the WLPD device 202 via broadband or cellular communication. Of course, these embodiments are merely exemplary and are not limiting or exhaustive.

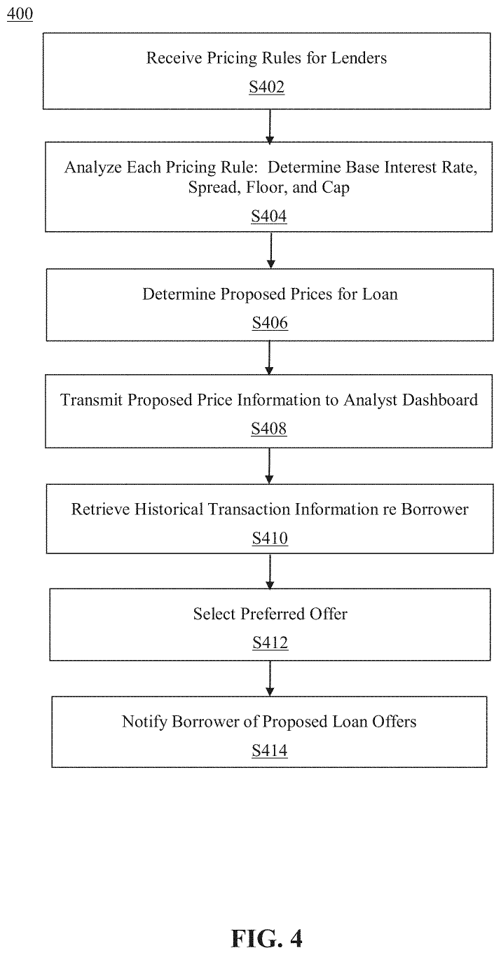

Upon being started, the automated wholesale loan pricing determination module 302 executes a process for using pricing rules, interest rate reference data, and business scenarios to determine possible pricing for wholesale loans. An exemplary process for using pricing rules, interest rate reference data, and business scenarios to determine possible pricing for wholesale loans is generally indicated at flowchart 400 in FIG. 4.

In process 400 of FIG. 4, at step S402, the automated wholesale loan pricing determination module 302 receives pricing rules that are usable for determining a price of a wholesale loan. In an exemplary embodiment, each respective pricing rule is associated with a corresponding lender.

At step S404, the automated wholesale loan pricing determination module 302 analyzes each respective pricing rule in order to determine a base interest rate, a spread value, a floor value, and a cap value for each pricing rule. In an exemplary embodiment, each respective pricing rule may relate to a variable benchmark interest rate, such as, for example, the federal funds rate as published by the United States Federal Reserve, the London Inter-Bank Offered Rate (LIBOR), the Hong Kong Interbank Offered Rate (HIBOR), or the Canadian Deposit Offered Rate (CDOR). In this aspect, the spread value refers to a difference between the base interest rate and the calculated interest rate for the pricing rule; the floor value refers to the minimum interest rate for the pricing rule; and the cap value refers to the maximum interest rate for the pricing rule.

At step S406, the automated wholesale loan pricing determination module 302 determines a set of proposed prices for a particular loan. In an exemplary embodiment, as a result of the analysis of the pricing rules performed in step S404, there may be several possible prices for the loan, each being determined by application of the corresponding pricing rule. The variable benchmark interest rates typically vary on a periodic basis, such as, for example, a daily basis, and therefore, the determination of each proposed price for the loan may include determining a time interval during which each proposed price remains valid. In this aspect, the automated wholesale loan pricing determination module 302 may update each proposed price on a periodic basis, based on respective changes in the applicable benchmark interest rates. For example, when a particular benchmark interest rate varies on a daily basis, the update may be performed on an approximately daily basis, i.e. every 24 hours, or at an interval that is greater than 12 hours and less than 48 hours.

At step S408, the automated wholesale loan pricing determination module 302 transmits the information relating to each proposed price for the loan to an analyst dashboard. In an exemplary embodiment, the analyst dashboard is implemented as a graphical user interface (GUI) that is operable on a screen of a computer terminal associated with an analyst, i.e., a person that works with a potential borrower to facilitate an execution of the loan.

At step S410, the automated wholesale loan pricing determination module 302 selects a preferred offer from among the proposed prices for the loan. In an exemplary embodiment, the automated wholesale loan pricing determination module 302 may retrieve historical information that relates to other loan transactions that have previously been executed by the borrower, and then make a determination that the borrower would likely prefer one particular proposed price for the loan based at least in part on the historical information.

At step S412, the automated wholesale loan pricing determination module 302 notifies the borrower of the proposed prices for the loan. In an exemplary embodiment, the notification may be effected by transmitting an email message that contains the price information, and the message may also include a recommendation as to which proposed price has been selected as a preferred offer and other explanatory information regarding the advantages and disadvantages of each proposed price.

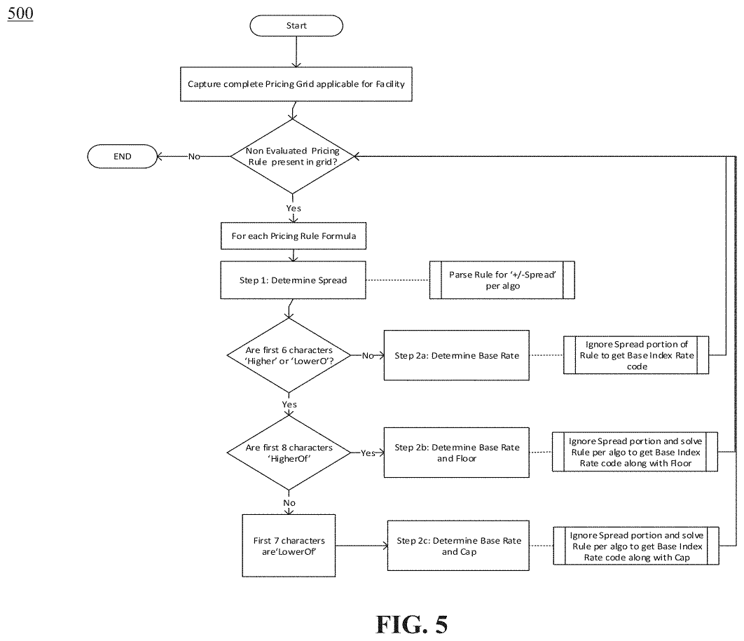

FIG. 5 is a flowchart 500 of a process for parsing a pricing rule, according to an exemplary embodiment. In the flowchart 500, a complete pricing grid that is applicable for a particular facility (i.e., a bank or other financial institution that works with wholesale loan lenders) is captured, and then a process for evaluating each pricing rule in the grid commences.

For each pricing rule formula, a first step is to determine a spread value as specified by the formula. In an exemplary embodiment, this determination is made by parsing the formula to determine a numerical value that is associated with text included in the text string “+/−Spread”.

The pricing rule formula is then analyzed to determine the applicable base rate, an applicable floor value, and/or an applicable cap value. This analysis is performed by parsing the text of the formula to determine whether the rule specifies “HigherOf,” “LowerOf,” or neither of these two qualifiers, and then identifying an applicable variable benchmark index. Then, if the rule specifies “HigherOf,” the formula is parsed to determine the floor value based on a numerical value associated with that portion of the formula, and if the rule specifies “LowerOf,” the formula is parsed to determine the cap value based on a numerical value associated with that portion of the formula.

The process is repeated until all pricing rules included in the original pricing grid have been fully evaluated.

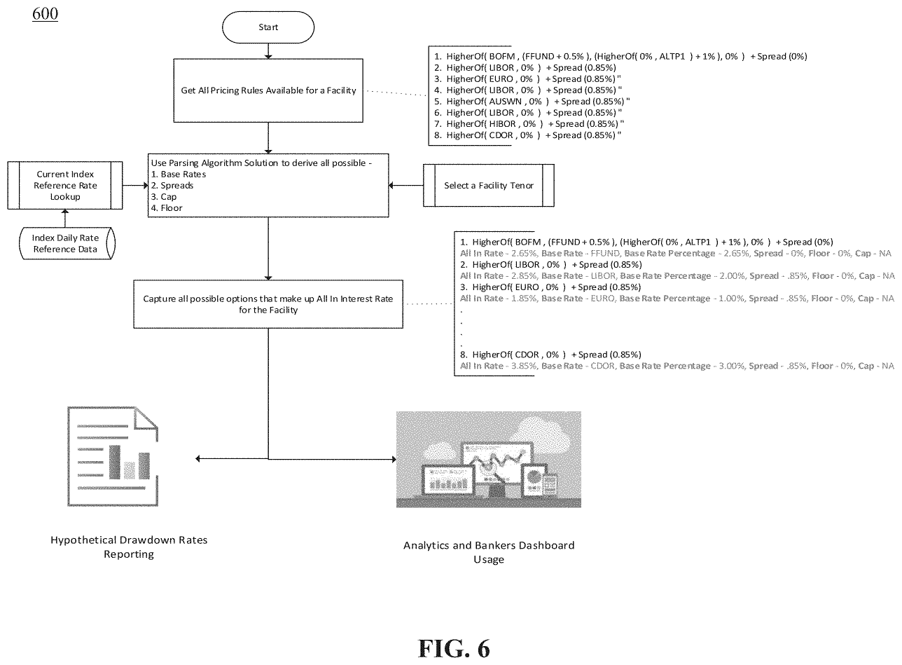

FIG. 6 is a diagram 600 that illustrates a hypothetical rate draw use case, according to an exemplary embodiment. In the diagram 600, in a first step, all pricing rules that are available for a facility are accessed, and then the parsing algorithm is used to derive all possible base rates, spreads, cap values, and floor values. A facility tenor selection is an input to the parsing algorithm, and the current index reference rates are another input, which is retrieved from an index daily rate reference database. Then, all possible options that make up a set of hypothetical all in interest rates is captured. These options are then forwarded to an analytics and bankers dashboard, and are also reported to predetermined users.

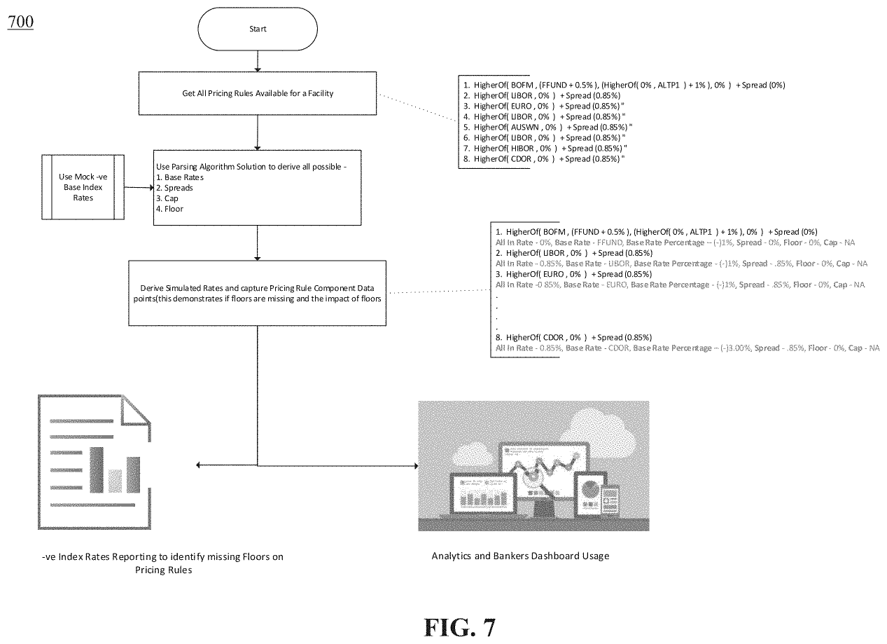

FIG. 7 is a diagram 700 that illustrates a simulation of a negative rate use case, according to an exemplary embodiment. In the diagram 700, in a first step, all pricing rules that are available for a facility are accessed, and then the parsing algorithm is used to derive all possible base rates, spreads, cap values, and floor values. A set of mock negative base index interest rates are an input to the parsing algorithm. Then, a set of simulated rates is derived, and pricing rule component data points are captured. These simulated rates and pricing rule component data points are then forwarded to the analytics and bankers dashboard, and are also reported to predetermined users for an identification as to whether any pricing rules are missing floor values that should be present.

Accordingly, with this technology, an optimized process for using pricing rules, interest rate reference data, and business scenarios to determine possible pricing for wholesale loans is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for determining a price for a loan, the method being implemented by at least one processor, the method comprising:
receiving, by the at least one processor, at least one pricing rule that is applicable for the loan, each of the at least one pricing rule relating to at least one variable benchmark interest rate;
analyzing, by the at least one processor, each of the received at least one pricing rule;
obtaining, for each of the at least one variable benchmark interest rate, a current index reference rate;
determining, by the at least one processor based on a result of the analyzing, at least one proposed price for the loan;
determining a time interval during which the determined at least one proposed price for the loan remains valid; and
notifying, by the at least one processor, a user of the determined at least one proposed price for the loan.

2. The method of claim 1, wherein the analyzing comprises determining, for each respective pricing rule:
a corresponding base interest rate;
a corresponding spread value; and
at least one from among a corresponding floor value and a corresponding cap value.

3. The method of claim 2, wherein each of the at least one pricing rule is associated with a respective wholesale lending facility.

4. (canceled)

5. (canceled)

6. The method of claim 1, further comprising:
when a predetermined time interval has elapsed since the determining of the at least one proposed price for the loan, updating a determination of the least one proposed price for the loan based on a change in the at least one benchmark interest rate.

7. The method of claim 6, wherein the predetermined time interval is greater than 12 hours and less than 48 hours.

8. The method of claim 1, further comprising displaying information that relates to the determined at least one proposed price for the loan on a dashboard user interface associated with a financial institution.

9. The method of claim 1, further comprising:
after the determining and before the notifying, retrieving historical information that relates to at least one loan transaction previously executed by the user;
selecting a preferred price for the loan from among the determined at least one proposed price for the loan based on the retrieved historical information; and
notifying the user of the selected preferred price for the loan.

10. A computing apparatus for determining a price for a loan, the computing apparatus comprising:
a processor;
a memory; and
a communication interface coupled to each of the processor and the memory,
wherein the processor is configured to:
receive, via the communication interface, at least one pricing rule that is applicable for the loan, each of the at least one pricing rule relating to at least one variable benchmark interest rate;
analyze each of the received at least one pricing rule;
obtain, for each of the at least one variable benchmark interest rate, a current index reference rate;
determine, based on a result of the analysis, at least one proposed price for the loan;
determine a time interval during which the determined at least one proposed price for the loan remains valid; and
notify, via the communication interface, a user of the determined at least one proposed price for the loan.

11. The computing apparatus of claim 10, wherein the processor is further configured to analyze each of the received at least one pricing rule by determining, for each respective pricing rule:
a corresponding base interest rate;
a corresponding spread value; and
at least one from among a corresponding floor value and a corresponding cap value.

12. The computing apparatus of claim 11, wherein each of the at least one pricing rule is associated with a respective wholesale lending facility.

13. (canceled)

14. (canceled)

15. The computing apparatus of claim 10, wherein the processor is further configured to:
when a predetermined time interval has elapsed since the determination of the at least one proposed price for the loan, update the determination of the least one proposed price for the loan based on a change in the at least one benchmark interest rate.

16. The computing apparatus of claim 15, wherein the predetermined time interval is greater than 12 hours and less than 48 hours.

17. The computing apparatus of claim 10, wherein the processor is further configured to display information that relates to the determined at least one proposed price for the loan on a dashboard user interface associated with a financial institution.

18. The computing apparatus of claim 10, wherein the processor is further configured to:
after the determination and before the notification, retrieve, from the memory, historical information that relates to at least one loan transaction previously executed by the user;
select a preferred price for the loan from among the determined at least one proposed price for the loan based on the retrieved historical information; and
notify the user of the selected preferred price for the loan.

19. A non-transitory computer readable storage medium storing instructions for determining a price for a loan, the storage medium comprising executable code which, when executed by a processor, causes the processor to:
receive at least one pricing rule that is applicable for the loan, each of the at least one pricing rule relating to at least one variable benchmark interest rate;
analyze each of the received at least one pricing rule;
obtain, for each of the at least one variable benchmark interest rate, a current index reference rate;
determine, based on a result of the analysis, at least one proposed price for the loan;
determine a time interval during which the determined at least one proposed price for the loan remains valid; and
notify a user of the determined at least one proposed price for the loan.

20. The storage medium of claim 19, wherein the executable code is further configured to cause the processor to analyze each of the received at least one pricing rule by determining, for each respective pricing rule:
a corresponding base interest rate;
a corresponding spread value; and
at least one from among a corresponding floor value and a corresponding cap value.
